(19) United States
(12) Patent Application Publication
(10) Pub. No.: US 2024/0189876 A1
(43) Pub. Date: Jun. 13, 2024

(54) BIOSOLID TREATMENT PROCESS AND SYSTEM

(71) Applicant: Ecoremedy, LLC, Pittsburgh, PA (US)

(72) Inventor: David E. Mooney, Pittsburgh, PA (US)

(73) Assignee: Ecoremedy, LLC, Pittsburgh, PA (US)

(21) Appl. No.: 18/585,869

(22) Filed: Feb. 23, 2024

Related U.S. Application Data
(63) Continuation of application No. 18/301,365, filed on Apr. 17, 2023.
Application No. 18/301,365 is a continuation of application No. 16/942,635, filed on Jul. 29, 2020, now Pat. No. 11,629,301.
(60) Provisional application No. 62/879,929, filed on Jul. 29, 2019.

(51) Int. Cl. B09B 3/40; B09B 101/25

(52) U.S. Cl. CPC B09B 3/40; B09B 2101/25

(57) ABSTRACT

A biosolids treatment system that treats human biosolids to produce thermal energy for self-consumption for the production of beneficial use products including low carbon ash, high carbon activated biochar, and Class A biosolids. The system includes a variable feed conveyor that conveys a biosolid feed into a dryer; a dryer that dries the biosolid feed to a predetermined moisture content to create one of a beneficial use products, where the predetermined moisture content is controlled by varying the speed of variable feed conveyors and a variable feed mixer; and a gasifier that converts the biosolid feed into two of the beneficial use products.

### BACKGROUND

There's a saying that “You can't avoid death and taxes.” You could add to that: human biosolids. Humans produce about 640 billion pounds of feces and 3.5 billion gallons of urine each year. If you think generating that amount of waste is unavoidable, consider the issue of disposing of it: Just as unavoidable.

In wealthier countries, disposal companies or governmental agencies dry the waste (in particular the fecal sludge/biosolids) using fossil fuel and land apply it as “natural fertilizer” or dispose of it in landfills. Some countries dispose of it in the oceans as well, though this practice is prohibited in most countries. Other countries incinerate the biosolids which generates horrible air quality concerns.

Since the US Clean Air Act of 1963, incineration of biosolids in the United States has been phased out due to air emission rates well in excess of permittable limits. Nearly no new incinerators have been permitted in the last two decades. In 2019, approximately 67% of all biosolids produced are land applied and 33% of all biosolids are landfilled. On Nov. 15, 2019, the U. S. EPA's Office of Inspector General (OIG), an independent review branch of the EPA, released a report reviewing EPA's biosolids regulatory program. The report identified 352 pollutants that cause severe environmental and human health concerns when leached into the ground and waterways that the EPA is not sufficiently monitoring. Upon reading the report, states independently placed moratoriums on land application of biosolids and landfills are no longer accepting biosolids for disposal creating the impossible situation of unstoppable biosolids production with no disposal options.

Thus, there exists a need for a human biosolids treatment solution that can handle human biosolids, remove its moisture, break down harmful chemicals, produce a biochar with desirable properties, with a minimal environmental footprint.

### SUMMARY OF THE EMBODIMENTS

A biosolids treatment facility that treats human biosolids to produce a low carbon ash (LCA) (that may be less than 10% carbon content), dried Class A biosolids, and/or carbon rich biochar products (HCAB) (that may be greater than 10% carbon content), where the feed rate into a dryer is modulated in response to a measured moisture content of blended human biosolids and recirculated dried Class A product.

As described herein, a gasifier may produce LCA and HCAB, while the dryer produces the Class A biosolids. As mentioned, discussed herein, the dryer's Class A biosolid may be conveyed back to the gasifier, which converts all carbon in the overall system to energy, with LCA as the only byproduct. This is made possible using the plume abatement heater, the absence of which leaves a functioning system where excess energy is recovered in solid form with the gasifier producing LCA and the dryer produces Class A biosolids OR the gasifier produces only HCAB and no Class A product or some combination of the dryer produces Class A biosolids and the gasifier produces HCAB.

While biosolids are mostly discussed herein, the treatment system is configured to use comingled materials generated by a wastewater treatment facility (WWTF) as well, including grit and screenings, fats/oils/grease (FOG), anaerobically digested biosolids, biosolids post thermal hydrolysis treatment, primary/secondary waste activate sludge, non-activated sludge in varying percent of composition as fuel sources for the gasifier without need for supplemental fuel.

### BRIEF DESCRIPTION OF THE DRAWINGS

FIG. 1 shows a figurative overview of the receiving and metering buildings.

FIGS. 2A-2C show multiple embodiment overviews of the treatment equipment.

FIG. 3 shows an overview of the process described herein.

FIG. 4A shows a top view of the gasifier conveyor assembly.

FIG. 4B shows a cross-section 4B-4B through the assembly in FIG. 4A.

FIG. 4C shows a detail 4c from FIG. 4B.

FIG. 4D a detail 4d from FIG. 4E.

FIG. 4E shows a cross-section 4E-4E through the assembly in FIG. 4B.

FIGS. 5A1 and 5A2 show side view illustrations of the gasifier and oxidizer.

FIG. 5B shows a side isometric view of the burn back prevention system within the gasifier.

FIG. 5C shows a top view of the burn back prevention system.

FIG. 5D shows a left side view of the burn back prevention system.

FIG. 5E shows a rear elevation view of the burn back prevention system.

FIGS. 5F and 5G show cross sections 5F-5F and 5G-5G through the assembly in

FIG. 5E, with the guillotine closed and open respectively.

FIG. 5H shows the detail 5H from FIG. 5F.

### DETAILED DESCRIPTION OF THE EMBODIMENTS

### 1. Facility Introduction

The novel biosolids treatment process and combination of equipment presents an alternative to the land application, incineration, composting, or landfilling of biosolids, all of which are increasingly problematic in biosolids management. The process, using the facility, converts dewatered municipal biosolids (“sludge cake”) generated at wastewater treatment plants (WWTPs) to renewable energy and three value added products (low carbon ash, high carbon biochar, and Class A dried biosolids) preferably without the use of supplemental fuels (natural gas, oil, biomass, etc.), which are not required.

An initial design of a first treatment facility's footprint was approximately 0.25 acres with site disturbance limited to the foundation footers and slab required for the storage and process buildings. A negative pressure one-story building houses the biosolids gasification and drying sections. The enclosed facility is not subject to leaching, runoff, or wind. There are no outfall pipes that discharge to surface streams or drainage channels and wastewater discharge from the facility may be routed to a wastewater treatment plant.

Ancillary equipment and structures located adjacent to the gasifying and drying process building may include mechanical equipment for receiving, storing, and conveying biosolids into the building. Conveyance and storage equipment for the Class A products may also be housed in the ancillary building.

Air emissions from the facility are very low to begin with and are further controlled by a wet scrubber and/or activated carbon filter. Air emissions from the facility are similar in content to combustion of natural gas.

### 2. Treatment Process and Equipment

The waste treatment process involves the thermal drying of dewatered biosolid to produce a Class A biosolid that can be used as a fertilizer, soil conditioner, and/or a renewable fuel product. Class A biosolids meet the requirements established under 25 Pa. Code § 271.932(a) in regard to pathogens and 25 Pa. Code § 271.933(b)(1)-(8) relating to vector attraction reduction, (also found in US EPA Part 503 Biosolids Rule, Chapters 2, 5, and 6), are nonliquid, and are unrecognizable as human waste.

The process may also produce a renewable fuel coproduct with as-is energy value≥5,000 Btu/lb as defined in 25 Pa. Code § 287.1 as a beneficial use product. Further, the biosolids gasifying drying facility satisfies the time-temperature requirement of Regime B as identified in Table 5-3 of US EPA Part 503 Biosolids Rule, Chapter 5 for Class A pathogen reduction.

The facility reduces the attractiveness of biosolids to vectors by drying the biosolids to >90% solids content as identified in Table 5-8, Option #8 of US EPA Part 503 Biosolids Rule, Chapter 5 for Class A vector attraction reduction. The system can process dewatered biosolids cake as wet as 15% total solids content.

The unloading process and storage may be maintained at a negative pressure and minimal onsite storage in a building maintained at a negative pressure may ensure all odors are contained inside the building thereby minimizing nuisance complaints.

### 2.1 Pre-Processing Overview

To put the system in context, it may be helpful to review the process from the step of biosolids sludge delivery to the treatment system, it being understood that the delivery steps may be performed in many other ways.

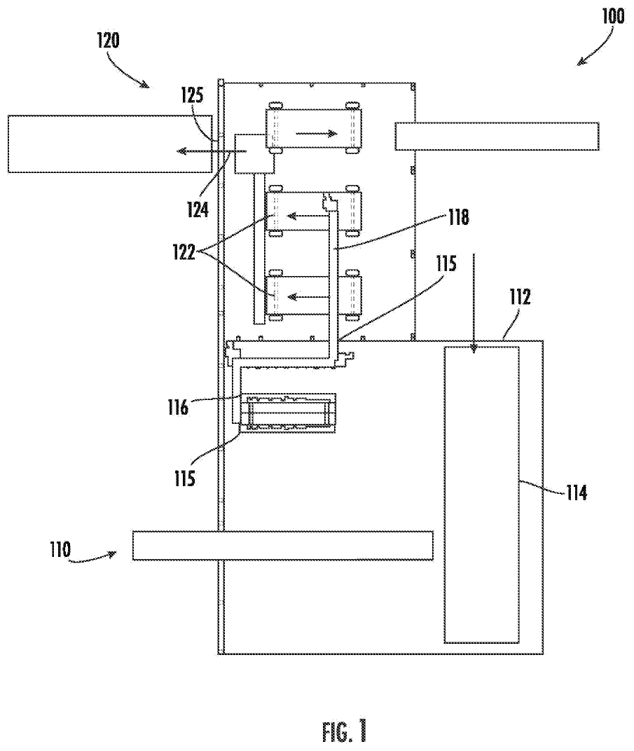

FIG. 1 illustrates an overview of the sludge receiving and metering facility 100, which includes the sludge receiving building 110 (that receives the trucks) and sludge metering building 120 (where certain measurements are taken the sludge is prepared before treatment). The sludge receiving building includes the rollup door 112 that allows trucks to access the sludge receiving building 110 and in particular the building's interior unloading bay 114. The sludge receiving and metering facility 100 includes an elevating conveyor 116 that conveys sludge received from the trucks upwards to a metering building conveyor 118 that spans the buildings 110, 120 via a port 115 into the sludge metering bins 122 located in the sludge metering building 120.

Within the metering building 120, sludge may be tested and stored before final transfer (which could be done via a treatment facility conveyor 124 (which may be a screw conveyor) that exits through a treatment port 125 between the metering building 120 and the treatment facility/building 200. Arrows indicate the direction of material flow. Within the metering building 120, technicians may test the sludge for chemical composition, moisture content, weight, volume.

The metering bins 122 may be graduated indicating the volume at different levels. A technician may record the sludge level before and after filling each metering bin 122, calculating the displaced sludge volume, and thus the mass flow rate entering the treatment building 200 can be calculated with the bulk density of the material.

### 2.2 Treatment Facility Operation

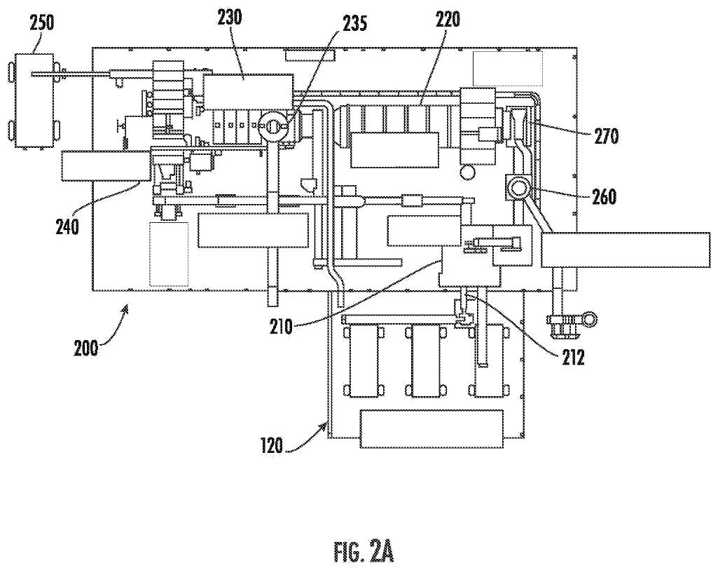

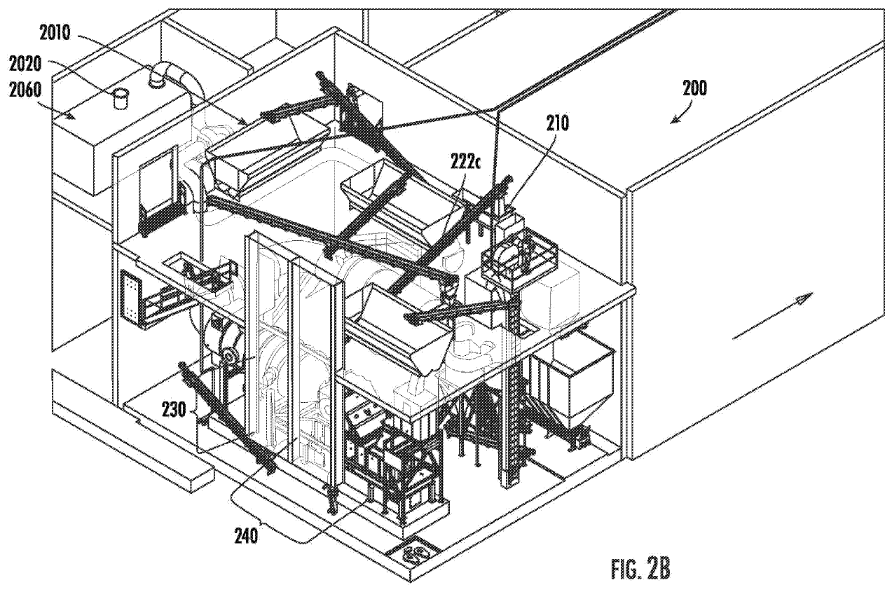

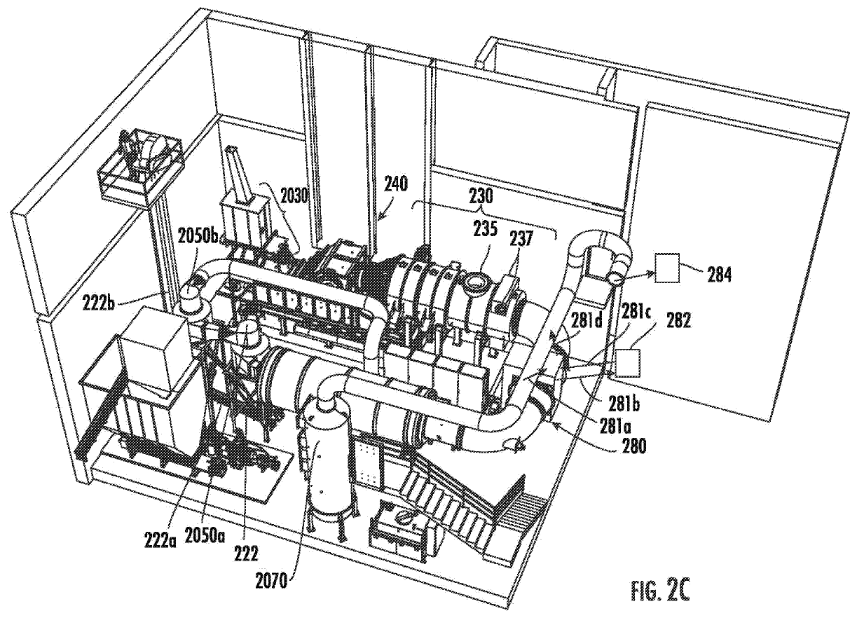

As shown in FIG. 2A (a simple overview) and 2B/2C (a more detailed and thorough view) treatment facility conveyors 124 deliver the sludge to the treatment building 200, and in particular a conventional biosolids mixer 210 (paddle, pug mill, pin mixer, or other) within a treatment building 200 where wet biosolids cake (average of 20% solids, ranging from 10% to 50% solids) is mixed with recirculated dried Class A product (average of 93% solids) from an output 222 of the dryer 220, to create a blended feed mixture (mixed biosolids) ranging between 50% to 75% total solids. The mixed biosolids are conveyed (via conveyor 222a and vertical lift conveyor 222b) to the direct contact, rotary drum dryer 220 for heat treatment that yields Class A product and also sent to the gasifier 240 via conveyors 222c and mixers to the gasifier metering bin 2030 as the exclusive fuel source for generating the thermal energy needed to dry the mixed biosolids to >90% total solids. The mixed biosolids are the sole energy source for the evaporation of water from the mixture. The gasifier 240 described herein may be of the type described in U.S. Pat. No. 6,948,436, the contents of which are incorporated by reference as if fully set forth herein.

The biosolids gasifier 240 heats the wet mixed biosolids using self-sustaining heat recovery from the system in an oxygen deficient chamber where the biosolids are converted to volatile gases (syngas) and low carbon ash or high carbon biochar, depending upon process purpose. The ash/biochar is automatically conveyed from the system as a beneficial byproduct for use as a soil amendment, fertilizer, or activated carbon filter media (as described below).

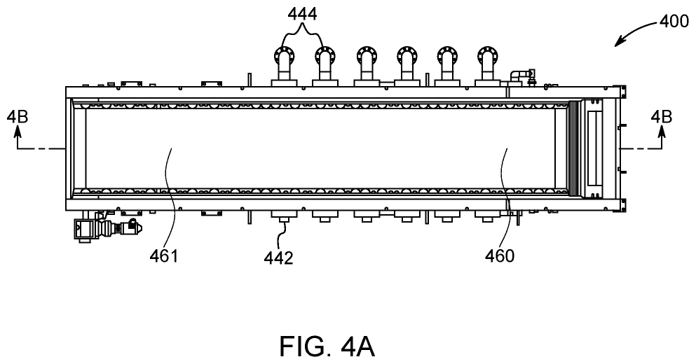

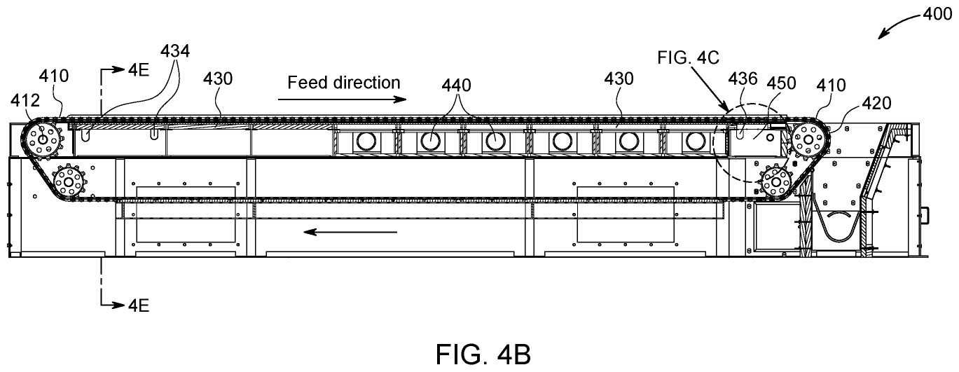

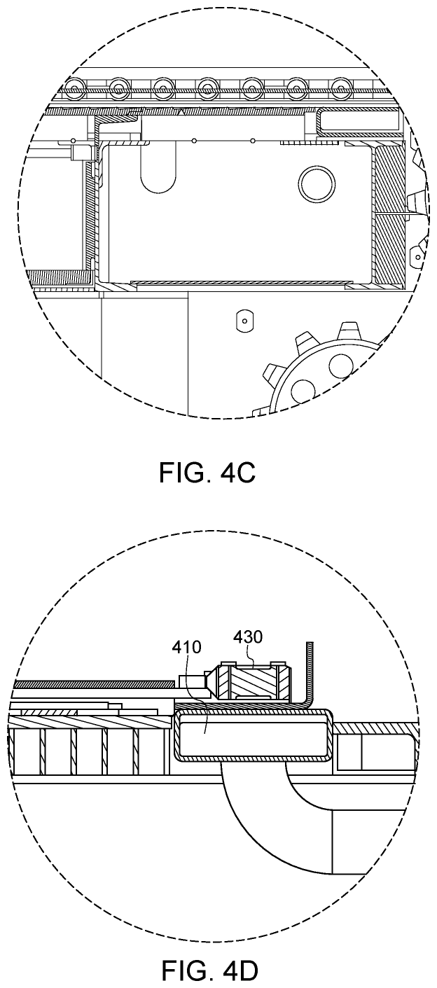

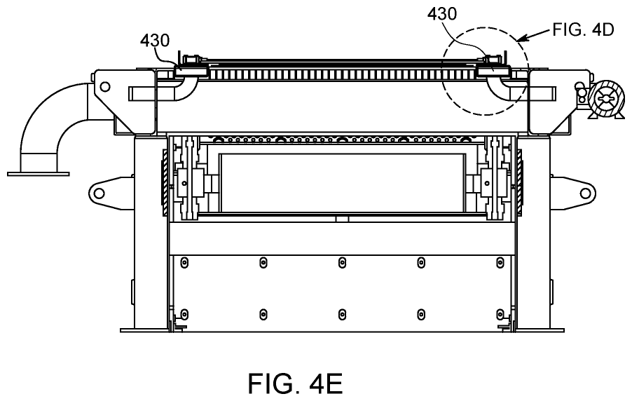

FIGS. 4A-4E show details of the gasifier 240 and in particular the gasifier belt assembly 400. The belt 460 may be air permeable and is attached to a pintle chain 410 driven by driving gears 412. Idler wheels (not shown) along the length of the assembly 400 may ensure that the chain 410 does not sag and thus keep the chain 410 engaged to the driving gear(s) 412. Rotation of the gears 412 drives the chain 410, which in turn advances the belt 460, which yet further in turn, advances feed through the gasifier 240.

The operating temperature within the gasifier 240 may range between 900F-1700 F. Extending along the length of the gasifier 240 along both sidewalls of the gasifier 240 are cooling guide rails in the form of ducts 430 on which a pintle chain 410 that drives the a gasifier belt assembly 400 rides. To manage the temperature of the gasifier pintle chain 410 that is exposed to such high heat, the cooling rails 430 are cooled using ambient air to transfer heat from beneath the cooling rails.

Specifically, the gasifier belt assembly 400 is driven by the pintle chain 410 guided by cooling guide rails 430 within the gasifier 240. To prevent the temperature of the pintle chain 410 from exceeding metallurgical design limits, a cooling system cools the cooling rails 430, which in turn cools the chain 410. The belt assembly 400 also includes air zones 440 fed by inlets 444 that cool the assembly 400 and in particular the belt 460.

An enclosed chamber 450 directly beneath the pintle chain forms the cooling guide rails 430 that is further cooled with air (force draft or induced draft) through a source to maintain the temperature of the guide rails 430 from exceeding 650 F.

The air system for the cooling guide rails 430 air enters (forced or drawn in) an inlet 434 of the cooling rail 430 at near ambient temperature and exits the cooling rail 430 at an outlet 436 at a temperature less than 650F depending on the volume flow rate of the cooling air. The hot exhaust air exiting the cooling rails 430 (<650F) is routed to the blend box 235 of the oxidizer 230 to recycle the hot air for beneficial use in evaporating moisture from the sludge in the dryer 220. The cooling rail 430 extends the service life of the pintle chain 410 by keeping it from experiencing excessively high temperatures which may degrade the metallurgical integrity of the chain.

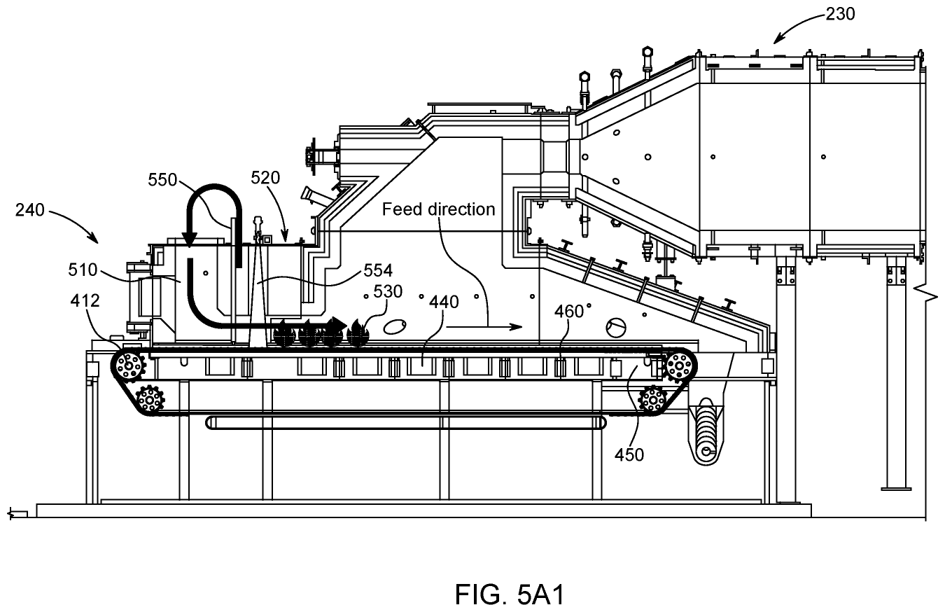

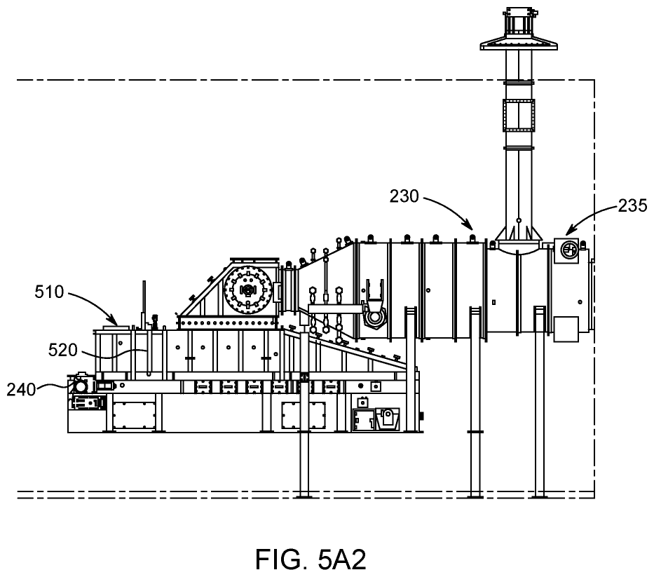

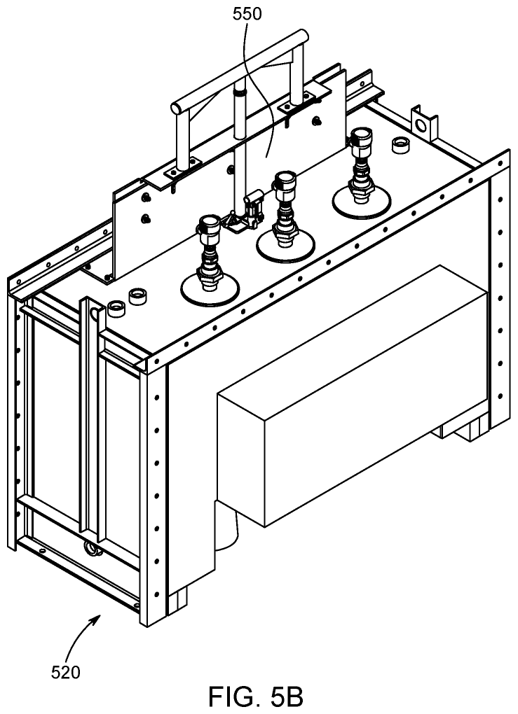

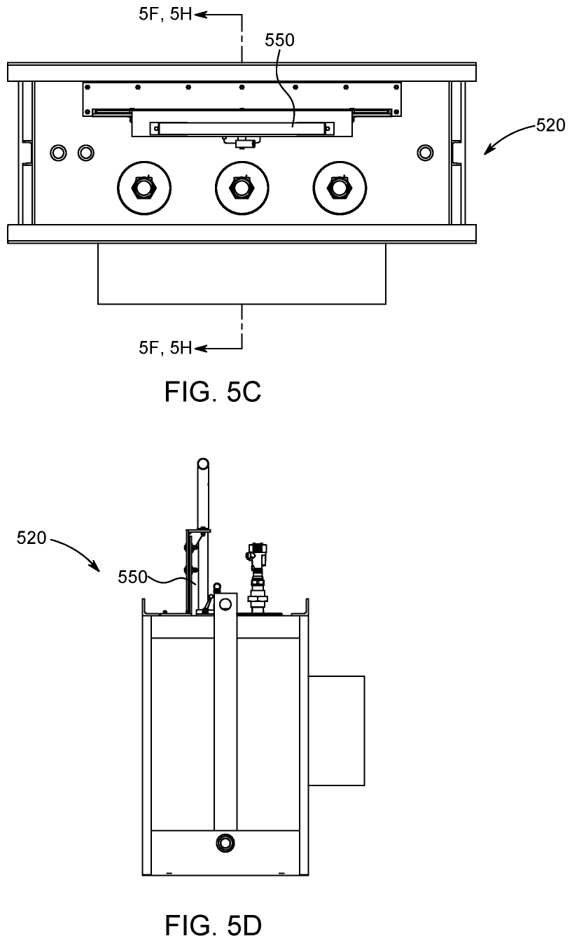

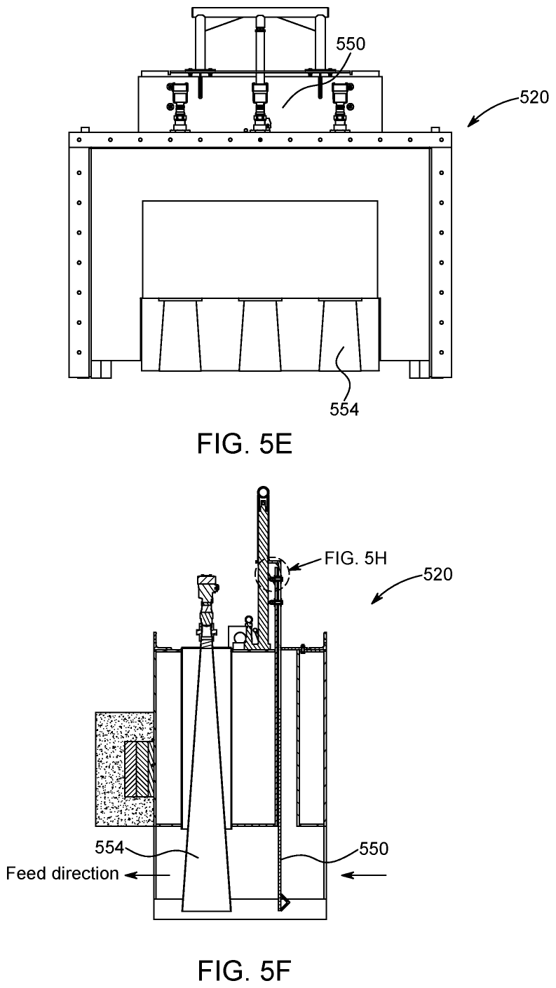

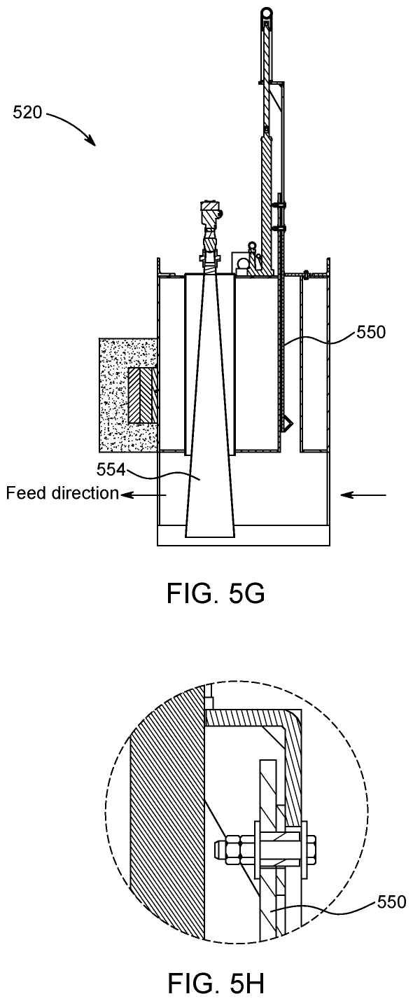

The self-sustaining exothermic energy release occurring within the gasifier 240 yields temperatures ranging from 900F-1700F and to provide operator safety and prevent potential damage to equipment during an unanticipated power outage, a burn-back prevention system, as shown in detail in FIGS. 5A1-5H, transfers energy from burning feed 530 in the gasifier 240 to a burn back prevention boiler tank 520 with water therein. The heated water turns into steam that the system directs (through piping) back into the feedstock inlet 510, which is used to prevent the burning of the feed 530 closer to the feedstock inlet 510.

In some more detail, during an emergency power outage, the gasifier belt assembly 400 that drives the belt 460 on which grates 461 rest, the belt assembly 400 stops with a full pile of hot feed in various stages of gasification. With the belt assembly 400 no longer moving forward, the gasifying feeds begins to burn backwards toward the inlet hopper 510. The burn back prevention boiler 520 prevents the burn-back event from igniting feedstock queued in the inlet hopper 510, outside the gasifier 240. The burn-back prevention boiler 520 surrounds the entrance to the gasifier 240 with water chambers on both sidewalls and the top of the gasifier belt assembly 400. As burning feed creeps toward the gasifier inlet hopper 510, the fire will eventually make its way under the boiler 520 where the energy in the fire heats the water chambers and generates steam. The transfer of energy to the water slows the propagation of the burning toward the inlet hopper 510. The steam generated in the boiler 520 is routed to the inlet fuel hopper 510 where it displaces air and suppresses the oxygenation of the flame, further extinguishing the burn-back event.

A guillotine gate 550 is incorporated into the burn-back prevention boiler 520. The guillotine gate 550 is used to establish the desired feed bed depth entering the gasifier 240 by scalping the feed at a predetermined set point depth as measured by sensors 554. Incorporating the guillotine gate 550 into the burn-back prevention boiler 520 ensures the guillotine gate 550 remains cool and prevents warping that can occur during a burn-back event, a common downfall for all guillotine gate metering devices. The guillotine gate 550 enhances burn-back prevention by further blocking air from entering the gasifier 240 and oxygenating the burn-back event. The guillotine gate 550 and burn-back prevention boiler 520 together prevent a burn-back event from making it to the fuel hopper 510.

Radar level measuring sensors 554 may be incorporated into the burn-back prevention boiler 520 to constantly measure the depth of the fuel bed entering the gasifier 240 confirming the setting of the guillotine gate 550. Should the radar level sensor 554 measure a bed depth that does not correspond to the guillotine gate setting, an alarm is displayed on the automated control system to alert the operator that the fuel system is not performing as specified.

The volatile syngas is channeled into a separate chamber downstream from the gasifier 240 to an oxidizer 230 where controlled combustion is achieved. Combustion occurs when adequate air is introduced to the syngas in the oxidizer balancing the combustion equation resulting in exothermic energy release achieving temperatures ranging between 1800F-2200 F.

The hot flue gases leave the oxidizer 230 and enter a flue gas tempering chamber (blend box) 235 where ambient air and moist recirculated dryer exhaust are mixed with the hot flue gas to achieve a controlled “tempered” flue gas temperature in the range of 700F-1400F, depending on biosolids characteristics and process purpose.

The blend box 235 is designed to mix the hot oxidizer flue gas (>1800F) with ambient air (+/−70F) and moist recirculated dryer (dryer 220) exhaust (180F—240F) to a set target temperature (700F—1400F). The target temperature is achieved by controlling the induced ambient air with a temperature-controlled damper operating from a thermocouple placed in a strategic location within the blend box 235 and the recirculated dryer exhaust with a variable frequency drive (VFD) on a recirculation fan motor that allows the operator to vary the flow rate of the recirculated dryer exhaust. Together, these two control points enable an operator (or automated operating controls but discussed herein as operator) to achieve accurate and stable temperature control exiting the blend box 235.

Contained within the blend box 235 is a shell and tube air-to-air heat exchanger designed to preheat ambient air for use in the gasification process (this gasifier air preheater is within the blend box 235, with visible inlet/outlets 237 in FIG. 2C)) and further lower the flue gas temperature to a “target” temperature. Furthermore, the tubes of the gasifier air preheater cause flue gas turbulence ensuring complete blending of gases for a uniform gas temperature exiting the blend box 235.

When sludge characteristics and process purpose allow, a customized two-pass, crossflow, plume abatement heat exchanger 280 (plume abatement HX) is installed between the gasifier air preheater and the dryer inlet. The tempered flue gas exiting the blend box 235 is used to heat the dryer exhaust in two steps. First, after passing through the mechanical cyclone (2050a, 2050b) and then the wet scrubber 2070 of the emission train (each removing further particulate, following the arrows and piping as shown), the saturated exhaust from the wet scrubber 2070 is routed through piping 281a to the plume abatement HX 280 where excess energy, not needed for the evaporation of moisture from the mixed biosolids, is used to heat the exhaust gases to a controlled temperature thereby dropping the relative humidity of the flue gas stream prior to entering, through additional piping 281b, a activated carbon filter (ACF) 282. Low relative humidity gas flow maximizes the performance of activated carbon. High temperature flue gas minimizes ACF performance so accurate temperature control of the heated gas may be a design consideration

After the ACF 282, the flue gas passes through the piping 281c in a second pass of the plume abatement HX 280 to superheat the exhaust to minimize plume before routing the exhaust through piping 281d to the final discharge point 284 to atmosphere.

The heat source for the plume abatement HX 28 is the tempered flue gas exiting the blend box 235. In the same manner that it is important to control temperature entering the ACF 282, control of the temperature of the hot flue gas may be maintained while entering the dryer 220. The dryer inlet temperature may be controlled using a system of dampers in the flue gas stream that direct flow through the plume abatement HX 280. In this manner, accurate control of both gas streams (entering the ACF 282 and entering the dryer 220) may be controlled to target temperatures set by the operator. Target temperatures entering the dryer 220 may range between 600 F-1100 F. The direct contact dryer 220 may be conventional to industry.

A portion of the dried Class A product ranging between 90% and 95% total solids as measured by an inline moisture sensor mounted in the Class A reclaim conveyor may be recirculated from the dryer outlet 222 as discussed above for blending with the inbound wet biosolids cake. The ratio of dry to wet biosolids for the mixer is determined by an inline moisture sensor 212 on the discharge of the mixer 210 and manually checked by periodic operator testing.

After much testing, the inventors found that flexibility to accurately control the mixer output to a range between 35% to 75% solids content is necessary to treat all varieties of municipal sludge with keeping below the sticky phase of the sludge, a phase that makes the operation challenging to manage. This mixed sludge quality is determined by the target fuel specifications for the gasifier 240.

Target temperature flue gas exits the blend box 235 and plume abatement HX 280 before entering a direct contact dryer 220 where it is the heat source for evaporating the water from dewatered mixed biosolids ranging between 35% to 75% solid content (same blended biosolids used for the gasifier fuel). The dried product may be conventionally sold as Class A product that is ≤ 10% MC (90% DM). The system may recycle the dried Class A product for mixing with incoming dewatered biosolids cake at ranging from 15% solids to >30% solids content.

The blended biosolid mixture (“mixed biosolids”) may be used as the exclusive fuel for the gasifier 240 and the input biosolids to the direct contact dryer 220. With the plume abatement HX 280 installed, the closed-loop system is estimated to be+/−94% efficient for energy repurposing.

The evaporated water from the biosolids pass from the dryer 220, through a high efficiency cyclone collectors 2050a, 2050b (260, 270 in FIG. 2A) to capture 99% of particulate matter larger than 10 micron (PM10), then through a three-stage wet scrubber system 2070 equipped with alkaline treatment or a combination of a venturi scrubber and packed bed chemical scrubber (together or apart the flue gas conditioning train) to ensure the capture of the majority of the remaining PM and treat for residual odors and SO2 prior to emitting to the atmosphere.

The flue gas conditioning train aids long term performance of the process equipment that is the plume abatement heat exchanger. The flue gas conditioning train removes particulate matter from fouling the plume abatement heat exchanger and neutralizes corrosive chemicals thereby preventing corrosion of the heat transfer surface of the plume abatement heat exchanger. In this manner, the equipment components that constitute the flue gas conditioning train are process equipment and not dedicated emission control equipment.

The clean water vapor plume is drawn from the system using an induced draft fan 2010 that blows the moist exhaust through an activated carbon filter 2060 to perform final pollutant polishing prior to exiting the facility stack 2020.

Controlling the relative humidity of the flue gas imay be done before entering the activated carbon filter. As previously stated, the system conditions relative humidity using the first pass of the plume abatement heat exchanger and/or using the energy recovered from the gasifier chain cooling rails to reheat the flue gas thereby reducing the relative humidity of the flue gas.

### 3. Process Byproducts and Design Considerations

The treatment process produces three types of beneficial coproducts. The process begins by mixing dewatered biosolids cake (ranging from 90% water content to 50% water content) with recirculated dried Class A biosolids (+/−7% water content) to create a resulting mixed biosolids (ranging between 50% water content to 25% water content) for use as the exclusive gasifier fuel and the inlet material to the dryer. The three coproducts generated from the system are:

1. Low carbon ash (LCA)—This coproduct has beneficial use as a fertilizer, alternative liming material for alkaline stabilization, and/or ingredient for improving the strength and porosity characteristics of building materials. The LCA is automatically conveyed out of the gasifier to an ash collection bin where it may be periodically hauled offsite.

2. High carbon activated biochar (HCAB)—This coproduct has beneficial use as a soil amendment, activated carbon filter media, and/or ingredient for improving the strength and porosity characteristics of building materials. The HCAB is automatically conveyed out of the gasifier to a collection bin where it may be periodically hauled offsite.

3. Excess dried Class A biosolids (7% water content) can be collected for use as a Class A fertilizer and/or alternative renewable fuel source. Class A Biosolids is conveyed to a collection bin where it may be periodically hauled offsite.

As described herein, the gasifier 240 may produce LCA and HCAB, while the dryer 220 produces the Class A biosolids. The dryer's Class A biosolid may be conveyed back to the gasifier 240, which converts all carbon in the overall system to energy, with LCA as the only byproduct. This is made possible using the plume abatement heater, the absence of which leaves a functioning system where excess energy is recovered in solid form with the gasifier producing LCA and the dryer produces Class A biosolids OR the gasifier produces only HCAB and no Class A product.

The treatment system gasifier/oxidizer arrangement 240, 230 uses mixed biosolids as the exclusive fuel source for the treatment process. Volatile syngas, predominantly hydrogen and carbon monoxide, is produced in the gasifier 240 and pulled into the oxidizer 230 by the draft that is established and maintained by an induced draft (ID) fan 2010 located at the end of the process following the wet scrubber and before the activated carbon filter. The production of syngas is an exothermic reaction resulting in temperatures (>900 F) adequate to sustain the carbon conversion operation and kill all pathogens.

In operation, the mixed biosolids fuel may remain in the gasifier 240 at temperature>900 F for 30-90 minutes. The gasifier 240 operates under a controlled draft.

The resulting ash from the gasifier 240 is one of the stated beneficial use products of the process. The ash may be stored in a covered 30-yard roll-off container providing weeks of storage. Once full, the roll-off container may be replaced with an empty 30-yard roll-off without stopping the process.

The duration of product exposure to elevated temperatures within the gasifier 240 kills all pathogens for Class A product and may thermally destroy Per- and polyfluoroalkyl (PFAS) compounds that are extremely harmful to human health to trace limits. The solids content of >90% satisfies the VAR requirement for Class A product. The gasifier ash may be tested for metals content to prove their qualification as Class A land application product. In the oxidizer 230, the volatile syngas is mixed with ambient air to balance the combustion equation and oxidation occurs, reaching temperatures in excess of 2000 F, which may thermally destroy vapor phase PFAS compounds to trace limits.

A controlled and consistent temperature entering the dryer 220 is achieved by mixing the hot flue gas from the oxidizer (>1800F) with ambient air and recirculated moist flue gas from the dryer 220 exhaust in a tempering chamber called the blend box.

Target dryer inlet temperature may be achieved with a temperature-controlled damper on the ambient air inlet. Ambient air supply for the blend box comes from the sludge receiving and storage and metering buildings 110, 120 thereby establishing the negative pressure to achieve odor control.

The tempering air flow into the blend box may result in air changes every hour in the sludge storage rooms that exceed limits imposed for office space and hospitals.

In addition to benefiting from its temperature cooling properties, recirculated flue gas is conventional practice for reducing NOx emissions. Once in the dryer 220, the tempered flue gas comes in direct contact with the mixed biosolids evaporating the moisture to a dried solids condition of >90% satisfying Class A requirements.

The dried biosolids product is one of the stated beneficial use products of the process described herein. The Class A dried biosolids product may be stored in a 40-yard roll-off container providing 10 days of storage. Once full, the roll-off container is replaced with an empty 40-yard roll-off without stopping the process.

The duration of product exposure to elevated temperatures (mean temperature is >450 F) within the dryer is 12 minutes satisfying the pathogen kill requirements for time and temperature for Class A product. The solids content of >90% satisfies a VAR requirement for Class A product. Dried biosolids may be tested for metals content to prove their qualification as Class A product. Furthermore, a proximate analysis may be performed on the dried solids to confirm the energy content is ≥ 5000 Btu/pound satisfying the requirement to sell the product as a renewable fuel.

Air emissions are controlled with a high efficiency mechanical cyclone collector to capture>99% of particles larger than 10 microns. The flue gas stream exits the cyclone to a 3-stage wet scrubber with alkaline treatment or a combination of a venturi scrubber and packed bed chemical scrubber where the final particulate matter may be captured prior to passing through an activated carbon filter prior to emitting to the atmosphere. The flue gas conditioning train may use bleach and caustic soda to scrub odors and sulfur emissions, if necessary. The total wastewater from the process is scrubber blowdown which is routed to the headworks of the WWTP for processing.

The treatment process satisfies the time-temperature requirement of Regime B as identified in Table 5-3 of USEPA Part 503 Biosolids Rule, Chapter 5 for Class A pathogen reduction and reduces the attractiveness of biosolids to vectors by drying the biosolids to >90% solids content as identified in Table 5-8, Option #8 of USEPA Part 503 Biosolids Rule, Chapter 5 for Class A vector attraction reduction.

Beneficial products produced from the treatment facility are Class A products for land application and renewable fuel coproducts.

### 4. Material and Waste Inventory

There may be two chemical storage tanks for the operation of a wet scrubber, which may not exceed 50 gallons each. One tank may contain 12.5% concentrated solution of sodium hypochlorite (NaOCL, bleach) and the other may contain a 25% concentrated solution of caustic soda (NaOH, sodium hydroxide).

The sodium hypochlorite and caustic soda storage containers may be mounted above a containment basin. This basin nay be sized for full leakage potential and contain the material from both tanks if they both emptied at the same time.

In the event of a spill, the contents within the containment basin may be pumped into a secure container and properly disposed in an approved landfill. Operator protection is provided with a pull chain activated, heated shower with integral eye wash station located immediately adjacent to the chemical containment basin. The shower may drain to the headworks of WWTP.

There may be discharge water produced from the wet scrubber, which may be routed directly to a wastewater treatment facility (WWTP).

### 5. Waste Generation Process

A facility such as the one proposed may be chosen based on a desire to harness the currently land applied or landfilled dewatered sludge cake produced by a WWTP. There are more than 16,000 WWTP in the United States and all have a sludge disposal problem.

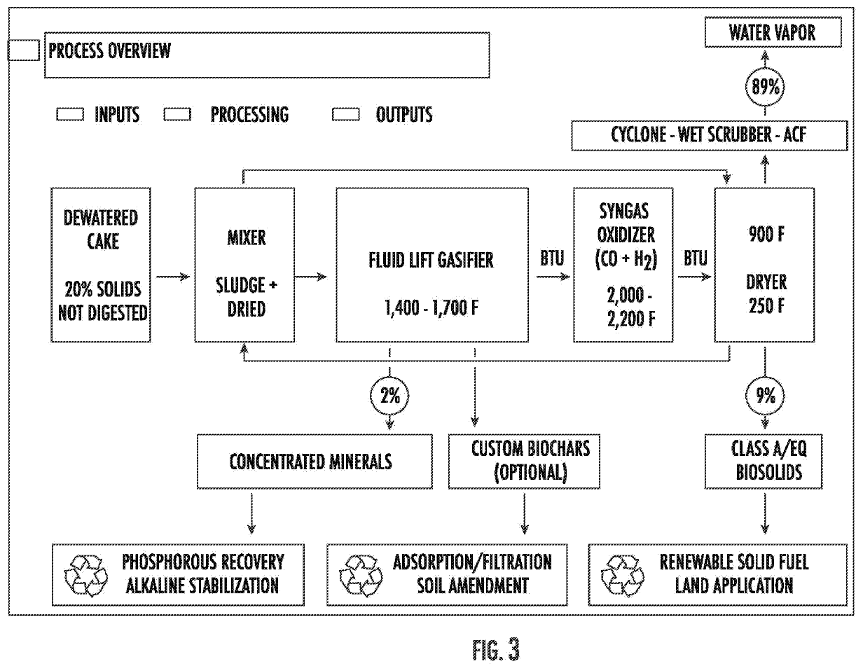

The process shown figuratively in FIG. 3 produces three types of beneficial use products from different process apparatuses. The project may not generate a waste other than blowdown from the flue gas conditioning train that may be discharged to the headworks of the WWTP for treatment. Said another way, the process may produce beneficial use products (BUPs), not wastes.

Dewatered biosolids cake ranging between 82% water content to 70% water content may be mixed with self-generated dried Class A biosolids at <10% water content to create a resulting mixed sludge for the gasifier and the dryer. This mixed sludge may be introduced into the gasifier at high temperatures (900F-1600F) where pyrolysis occurs, and volatile gases are removed and oxidized. After moving through the gasifier, two BUPs can result depending on the energy content of the biosolids cake:

1) Low carbon ash—This product is conveyed out of the gasifier to an ash trailer where it may be periodically sold for use as an all-natural fertilizer or a strength and hydroscopic enhancement ingredient for construction materials. If no market is available, the low carbon ash is benign and can be disposed in a landfill.

2) High carbon activated biochar—This product is conveyed out of the gasifier to an ash trailer where it may be periodically sold for use as an all-natural soil amendment, alternative to activated carbon filtration and adsorption media, or a strength and hydroscopic enhancement ingredient for construction materials. If no market is available, the biochar is benign and can be disposed in a landfill.

The thermal drying process may include of a direct contact rotary drum dryer with all associated product collection equipment. The mixed sludge that is sent to the dryer exits the dryer at 7% water content which may then be recycled back to the process to be incorporated with the dewatered biosolids cake via a mixer. A volume of recycled dried product can be adjusted for processing efficiencies. In this event, the non-recycled portion of the dried Class A biosolids is collected for sale as fertilizer or as a renewable energy fuel in the form of alternative coal. If no market is available, the Class A product can be used as landfill cover.

3) Class A Biosolids—This product is conveyed from the dryer outlet to Class A Biosolids bin where it may be temporarily stored before sold for beneficial uses.

Water blowdown from the wet scrubber may be sent directly back to the headworks of the WWTP to be treated. Water vapor from the drying process may exit the system via the exhaust stack and be sent to atmosphere.

One point worth noting is that the prior art systems have fed the dryer with a fixed flow rate of sludge and changed the firing rate of fossil fuel burners to react to the evaporation rate needed in the dryer. The system here can work differently than this by fixing the firing rate of the gasifier since the energy conversion through gasification must be controlled and then vary the feed rate to the dryer based on the available energy from the gasifier. This one control change is not done in the drying industry.

Stated another way, as mentioned above, the dryer exhaust temperature may have a predetermined target range, and rather than controlling that range like prior art systems that control a natural gas valve, the system herein can control the rate of the feed from the gasifier to the dryer to influence the dryer exhaust temperature, which may correlate to the quality of generated Class A Biosolids. A lower feed rate raises the temperature in the dryer (and thus as measured at a dryer exhaust sensor) and a higher feed rate lowers these temperatures.

Another notable unconventional control logic difference is that the induced draft (ID) fan 2010 is variable frequency driven (VFD) to control draft in the gasifier. The ID fan increases and decreases speed to maintain a constant draft in the gasifier when flue gas temperature controllers (induction air damper in blend box 235 and dryer exhaust recirculation fan in blend box) change the total system flue gas flow. A VFD ID fan is critical to maintain desired gasification performance whereas conventional biosolids drying systems have a fixed speed ID fan 2010 because a controlled draft is not important with fossil fuel burners.

In the process, as can be seen, the placement of the oxidizer is before the dryer rather than industry convention being the last piece of equipment prior to atmospheric discharge.

While the invention has been described as shown and described herein, a person of ordinary skill in the art would understand that various changes or modifications may be made thereto without departing from the scope of the claims.

I claim:

1. A human biosolids treatment system comprising:
a source of human biosolids;
a dryer configured to dry the human biosolids to a predetermined moisture content to create dried biosolid output;
a source of wet biosolids;
a mixer configured to mix the dried biosolid output and the wet biosolids and output a mixed biosolid feed;
a gasifier;
a variable feed conveyor; and
a controller;
wherein the variable feed conveyor is configured to variably recirculate the mixed biosolid feed to the dryer;
wherein the controller is programmed to modulate the recirculation rate into the dryer in response to a dryer exit temperature and/or a moisture sensor that corresponds to a target moisture content of the dried biosolids;
wherein the mixed biosolid feed is the sole fuel for the gasifier; and
wherein the gasifier is configured to convert the mixed biosolid feed into usable thermal energy for system use and at least one of low carbon ash and high carbon activated biochar.

2. The biosolids treatment system of claim 1, wherein the dryer creates low carbon ash and the gasifier creates high carbon activated biochar and Class A biosolids.

3. The biosolids treatment system of claim 1, wherein the treatment system includes a blended air intake to temper flue gas entering a dryer, wherein the blended air controls a target temperature in the dryer.

4. The biosolids treatment system of claim 1, wherein the treatment system includes a fan to recirculate moist dryer exhaust to temper flue gas entering a dryer, wherein blended air controls a target temperature in the dryer and reduces NOx emissions.

5. The biosolids treatment system of claim 1, wherein the system is configured to control carbon content of the biochar.

6. The biosolids treatment system of claim 1, wherein the biochar is used to filter air emissions from the system prior to discharge to atmosphere.

7. The biosolids treatment system of claim 1, wherein the biochar is mixed with the human biosolids as exclusive fuel for the gasifier.

8. The biosolids treatment system of claim 1, further including a water quench that cools the low carbon ash or the high carbon biochar prior to leaving the gasifier.

9. The biosolids treatment system of claim 1, further including a water quench that serves as an air lock to the gasifier enabling a negative pressure draft to be controlled within the gasifier.

10. The biosolids treatment system of claim 1, wherein the treatment system is capable of using different moisture content biosolid fuel sources.

11. The biosolids treatment system of claim 1, wherein the treatment system is configured to use comingled materials generated by a wastewater treatment facility (WWTF) including grit and screenings, fats/oils/grease (FOG), anaerobically digested biosolids, biosolids post thermal hydrolysis treatment, primary/secondary waste activate sludge, non-activated sludge in varying percent of composition as fuel sources for the gasifier without need for supplemental fuel.

12. The biosolids treatment system of claim 1, further including a plume abatement heat exchanger that treats gas exiting the dryer before sending the gas to an activated carbon filter.

13. The biosolids treatment system of claim 12, wherein gas exiting the activated carbon filter returns to the plume abatement heat exchanger for superheating before emission to atmosphere to minimize plume created by moisture in the gas.

14. The biosolids treatment system of claim 12, further including a control system that controls a wet scrubber that treats the gas exiting the dryer before the gas is treated by the plume abatement heat exchanger.

15. The biosolids treatment system of claim 1, further comprising an oxidizer located between the gasifier and dryer.

16. The biosolids treatment system of claim 1, wherein the variable feed conveyor is driven by a chain.

17. The biosolids treatment system of claim 16, wherein the chain is cooled by cooling rails that extend along a length of the chain.

18. The biosolids treatment system of claim 17, wherein the cooling rails comprise a duct with an inlet and outlet.

19. The biosolids treatment system of claim 1, wherein the gasifier includes a burn back prevention boiler, wherein the burn back prevention boiler comprises a water tank that boils water when the feed on the variable feed conveyor reaches a temperature adequate to boil the water, wherein the boiling water converts to steam, and wherein the steam is directed to a feed inlet to the gasifier to prevent feed in the feed inlet from catching fire.

20. The biosolids treatment system of claim 19, further comprising a guillotine gate that raises and lower to control a depth of feed on the conveyor.
